(19) United States
(12) Patent Application Publication
(10) Pub. No.: US 2026/0066811 A1
(43) Pub. Date: Mar. 5, 2026

(54) POWER SUPPLY SYSTEM AND METHOD

(71) Applicant: Delta Electronics (Shanghai) Co., Ltd., Shanghai (CN)

(72) Inventors: Junshan Lou, Shanghai (CN); Lei Wang, Shanghai (CN); Hong Liu, Shanghai (CN); Weiqiang Zhang, Shanghai (CN)

(21) Appl. No.: 19/316,500

(22) Filed: Sep. 2, 2025

(30) Foreign Application Priority Data
Sep. 4, 2024 (CN) 202411239642.7

(51) Int. Cl. H02M 7/23

(52) U.S. Cl. CPC H02M 7/23

(57) ABSTRACT

The present disclosure provides a power supply system and a power supply method. The power supply system includes a plurality of power units and at least one first voltage conversion circuit. The plurality of power units are electrically connected between an AC terminal and a DC terminal respectively. Each of the plurality of power units includes a main power circuit and an auxiliary circuit. The main power circuit includes a bus capacitor. The auxiliary circuit is electrically connected to the main power circuit. An input terminal of each first voltage conversion circuit is electrically connected to a bus capacitor of one power unit, and the first voltage conversion circuit is configured for converting a voltage of the bus capacitor to a first voltage and providing an auxiliary power required by the power supply system during a startup stage.

### CROSS-REFERENCE TO RELATED APPLICATION

This application claims priority to China Patent Application No. 202411239642.7, filed on Sep. 4, 2024, the entire contents of which are incorporated herein by reference for all purposes.

### FIELD OF THE INVENTION

The present disclosure relates to a power supply system and a method, and more particularly to an architecture for providing power to auxiliary circuit of a power supply system and a power supply method.

### BACKGROUND OF THE INVENTION

As an electronic power device, the power electronic transformer requires an auxiliary power for supplying power to the circuit thereof. The approach of supplying the auxiliary power affects the stability and reliability of the power electronic transformer.

In the conventional techniques, the power supply source of the auxiliary circuit may be an external power source such as a utility power or a battery. If the utility power is utilized as the power source, the power supply system of the power transformer cannot operate without the utility power. If the battery is utilized as the power source, an additional battery maintenance cost is required.

If the power supply source of the auxiliary circuit is not an external power, the auxiliary power supply may have two approaches. In the first approach, as shown in FIG. 1, the auxiliary power supply of the high-voltage side and the auxiliary power supply of the low-voltage side of each power unit are independent. In each power unit, the high-voltage side auxiliary power supply receives the voltage of the DC bus capacitor of the power unit for providing power to the high-voltage side circuit, and the low-voltage side auxiliary power supply receives the voltage of the DC terminal of the power supply system for providing power to the low-voltage side circuit of each power unit. However, in this approach, each high-voltage side auxiliary power supply requires a high step-down ratio converter to step down the voltage from the DC bus capacitor, then providing power to the high-voltage side circuit. The high step-down ratio converter has relatively large size and heavy weight. In addition, since the power supply system has a plurality of power units, a corresponding number of high step-down ratio converters are required, resulting in increasing the cost.

In the second approach, as shown in FIG. 2, the high-voltage side auxiliary power supply of each power unit receives the voltage of the DC bus capacitor of the power unit for providing power to the high-voltage side circuit. In each power unit, the low-voltage side auxiliary power supply is electrically connected to the high-voltage side auxiliary power supply for receiving the voltage of the high-voltage side auxiliary power supply and providing power to the low-voltage side circuit. However, in this approach, a corresponding number of high step-down ratio converters are also required. In addition, the DC bus capacitor needs to supply power to both the high-voltage side auxiliary power supply and the low-voltage side auxiliary power supply simultaneously, so the required power is higher.

Therefore, there is a need of providing a power supply system and method to obviate the drawbacks encountered from the prior arts.

### SUMMARY OF THE INVENTION

It is an object of the present disclosure to provide a power supply system and a power supply method. In the present disclosure, the voltage conversion circuit is utilized to receive the power of the bus capacitor of any one of the power units for providing the auxiliary power required by the power supply system during the startup stage. Since the power supply system and method of the present disclosure only require a small amount of voltage conversion circuits instead of multiple high step-down ratio converters to complete the auxiliary power supply of the power supply system, the cost, volume and weight of the power supply system are reduced. In addition, the power supply system and method of the present disclosure do not rely on an external power supply, thereby improving the applicability.

In accordance with an aspect of the present disclosure, a power supply system is provided. The power supply system includes a plurality of power units and at least one first voltage conversion circuit. The power supply system has an AC terminal and a DC terminal. The plurality of power units are electrically connected between the AC terminal and the DC terminal respectively. Each of the plurality of power units includes a main power circuit and an auxiliary circuit. The main power circuit includes a bus capacitor. The auxiliary circuit is electrically connected to the main power circuit. An input terminal of the first voltage conversion circuit is electrically connected to the bus capacitor of the main power circuit of one power unit, and the first voltage conversion circuit is configured for converting a voltage of the bus capacitor electrically connected to the first voltage conversion circuit to a first voltage and providing an auxiliary power required by the power supply system during a startup stage.

In accordance with an aspect of the present disclosure, a power supply method for a power supply system is provided. The power supply system has an AC terminal, a DC terminal, a plurality of power units and at least one first voltage conversion circuit. The plurality of power units are electrically connected between the AC terminal and the DC terminal respectively. Each of the plurality of power units includes a main power circuit and an auxiliary circuit, the main power circuit includes a bus capacitor, the auxiliary circuit is electrically connected to the main power circuit, an input terminal of each first voltage conversion circuit is electrically connected to a bus capacitor of one power unit, and wherein the power supply method includes steps of: (a) the first voltage conversion circuit receiving a voltage of the bus capacitor; (b) converting the voltage of the bus capacitor to a first voltage; and (c) providing an auxiliary power required by the power supply system during a startup stage.

The above contents of the present invention will become more readily apparent to those ordinarily skilled in the art after reviewing the following detailed description and accompanying drawings, in which:

### BRIEF DESCRIPTION OF THE DRAWINGS

FIGS. 1 and 2 schematically show conventional power supply systems respectively;

FIG. 3 is a schematic block diagram illustrating a power supply system according to an embodiment of the present disclosure;

FIG. 4A is a schematic block diagram illustrating a power supply system according to another embodiment of the present disclosure;

FIG. 4B is a schematic block diagram illustrating a power supply system according to another embodiment of the present disclosure;

FIG. 5 is a schematic block diagram illustrating a power supply system according to another embodiment of the present disclosure;

FIG. 6 is a schematic block diagram illustrating a power supply system according to another embodiment of the present disclosure;

FIG. 7 is a schematic flow chart illustrating a power supply method according to an embodiment of the present disclosure;

FIG. 8 is a schematic flow chart illustrating a power supply method according to another embodiment of the present disclosure; and

FIG. 9 is a schematic flow chart illustrating a power supply method according to another embodiment of the present disclosure.

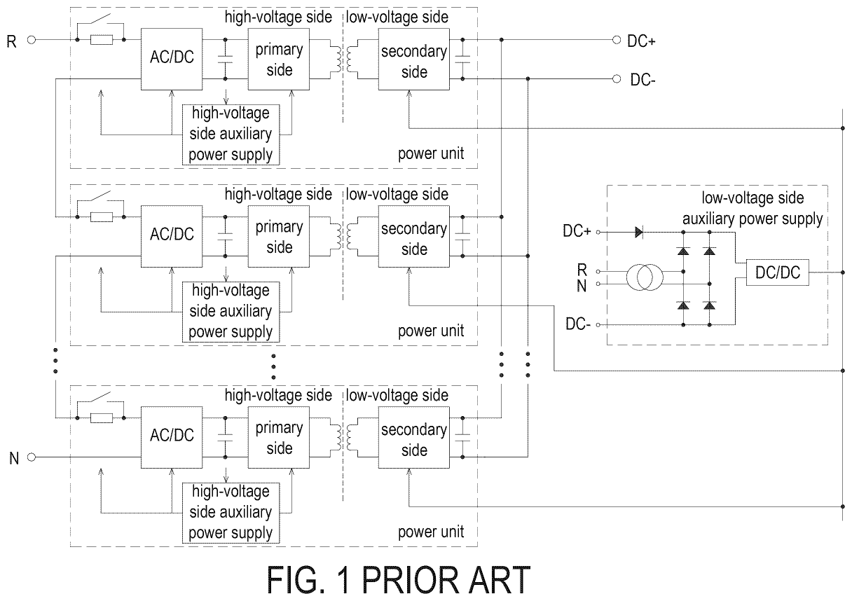

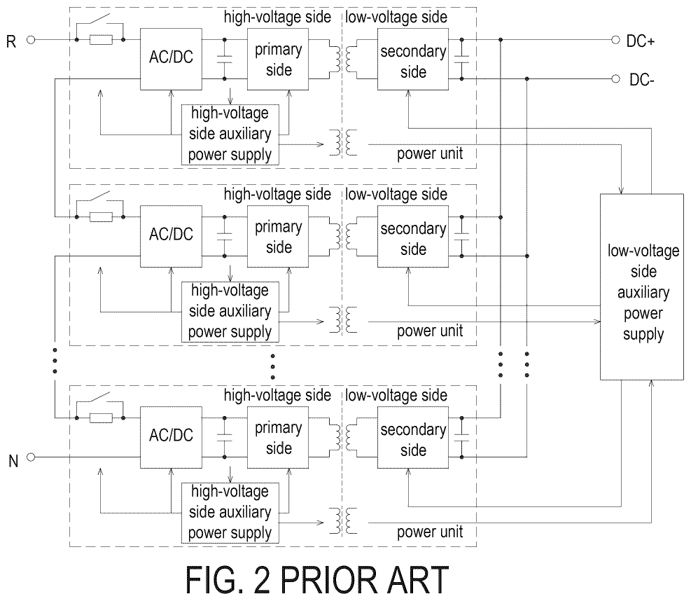

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

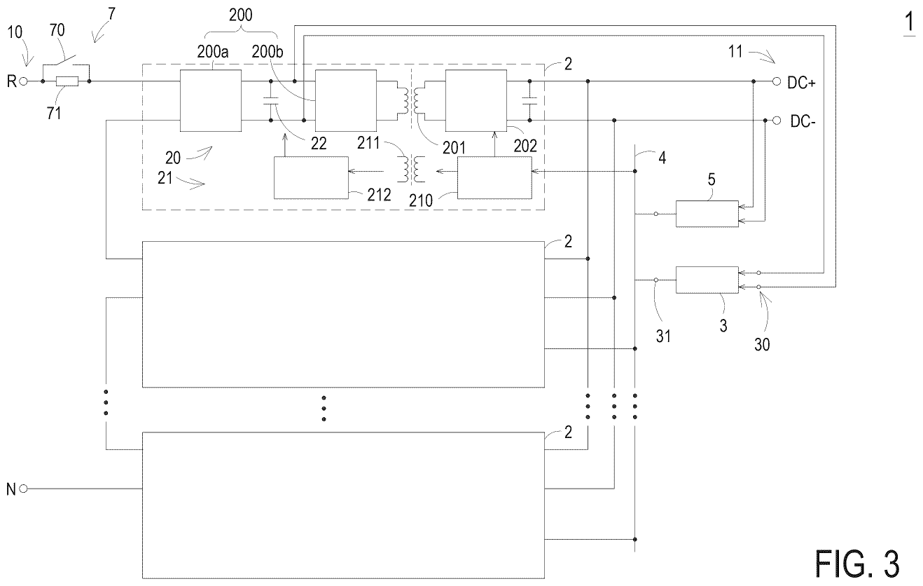

FIG. 3 is a schematic block diagram illustrating a power supply system 1 according to an embodiment of the present disclosure. As shown in FIG. 3, the power supply system 1 of the present disclosure has an AC terminal 10 and a DC terminal 11. In an embodiment, the DC terminal 11 has a DC positive terminal DC+ and a DC negative terminal DC− respectively. The power supply system 1 includes a plurality of power units 2 and at least one first voltage conversion circuit 3. The plurality of power units 2 are electrically connected between the AC terminal 10 and the DC terminal 11 respectively, and each of the plurality of power units 2 includes a main power circuit 20 and an auxiliary circuit 21. The main power circuit 20 includes a bus capacitor 22, and the auxiliary circuit 21 is electrically connected to the main power circuit 20. An input terminal 30 of each first voltage conversion circuit 3 is electrically connected to the bus capacitor 22 of the main power circuit 20 of at least one power unit 2, among the plurality of power units 2. An output terminal 31 of each first voltage conversion circuit 3 is electrically connected to the auxiliary circuit 21 of each power unit 2. The first voltage conversion circuit 3 is configured for converting a voltage of the bus capacitor 22 electrically connected to the first voltage conversion circuit 3 to a first voltage and providing an auxiliary power of the power supply system 1 during a startup stage. In an embodiment, the first voltage conversion circuit 3 is a DC/DC conversion circuit. In an embodiment, when the voltage at the DC terminal 11 is less than a setting voltage, the power supply system 1 is in the startup stage. The setting voltage is the voltage of the power supply system 1 operating normally, for example, the setting voltage is the output voltage of the power supply system 1 operating normally.

In the power supply system of the present disclosure, the voltage conversion circuit receives the power from the bus capacitor of one of the power units and provides the auxiliary power required by the power supply system during the startup stage. Instead of multiple high step-down ratio converters, the power supply system of the present disclosure only requires a small amount of voltage conversion circuits to provide the auxiliary power supply of the power supply system. As a result, the cost, volume and weight of the power supply system are reduced. In addition, the auxiliary power supply circuit of the present disclosure does not rely on an external power source, thereby improving the applicability.

Please refer to FIG. 3 again, the power supply system 1 further includes a low-voltage bus 4. The output terminal 31 of each first voltage conversion circuit 3 is electrically connected to the auxiliary circuits 21 of the plurality of power units 2 through the low-voltage bus 4. The low-voltage bus 4 receives the first voltage provided by the first voltage conversion circuit 3 as a bus voltage of the low-voltage bus 4. During the startup stage of the power supply system 1, the low-voltage bus 4 provides the first voltage to the auxiliary circuits 21 of the plurality of power units 2. Under this circumstance, the bus capacitor 22 provides the auxiliary power required by the power supply system 1 during the startup stage.

Please refer to FIG. 3, there is a pre-charge circuit 7 electrically connected between the AC terminal 10 and the power unit 2 of the power supply system 1. The pre-charge circuit 7 includes a switch 70 and a resistor 71 electrically connected in parallel. When the power supply system 1 is in a pre-charge stage, the voltage of the bus capacitor 22 is increased. When the power supply system 1 is in the startup stage, the first voltage conversion circuit 3 provides the auxiliary power to the power unit 2. Correspondingly, the voltage of the bus capacitor 22 electrically connected to the first voltage conversion circuit 3 is decreased, and the voltages of the bus capacitors 22 which are not electrically connected to the first voltage conversion circuit 3 is increased. When the startup stage is over, the first voltage conversion circuit 3 stops providing auxiliary power to the power unit 2. Correspondingly, the voltage of the bus capacitor 22 electrically connected to the first voltage conversion circuit 3 is increased and is equal to the voltage of other bus capacitors 22.

The power supply system 1 further includes a second voltage conversion circuit 5 electrically connected between the DC terminal 11 and the low-voltage bus 4. The second voltage conversion circuit 5 is configured for converting a voltage of the DC terminal 11 to a second voltage. After the startup stage, the second voltage conversion circuit 5 receives power from the DC terminal 11 and provides the auxiliary power to the power unit 2. In an embodiment, the second voltage conversion circuit 5 is a DC/DC conversion circuit. When the second voltage is higher than the first voltage, the low-voltage bus 4 receives the second voltage provided by the second voltage conversion circuit 5 as the bus voltage of the low-voltage bus 4. The low-voltage bus 4 provides the second voltage to the auxiliary circuits 21 of the plurality of power units 2. Under this circumstance, the DC terminal 11 provides the auxiliary power required by the power supply system 1. When the voltage of the DC terminal 11 is equal to the setting voltage, the power supply system 1 completes the startup stage, and the second voltage is higher than the first voltage. When the voltage of the DC terminal 11 is less than the setting voltage, the power supply system 1 is in the startup stage. At this time, the second voltage is less than the first voltage, and the low-voltage bus 4 receives the first voltage provided by the first voltage conversion circuit 3.

In the power unit 2, the main power circuit 20 includes a first power conversion circuit 200, a first transformer 201 and a second power conversion circuit 202. The first power conversion circuit 200 is electrically connected to the AC terminal 10, the first transformer 201 is electrically connected to the first power conversion circuit 200, and the second power conversion circuit 202 is electrically connected to the first transformer 201 and the DC terminal 11. The voltage of the first power conversion circuit 200 is higher than that of the second power conversion circuit 202. In other words, the first power conversion circuit 200 is regarded as a high-voltage side, and the second power conversion circuit 202 is regarded as a low-voltage side. In an embodiment, the voltage of the first power conversion circuit 200 is higher than 1500 volts (V). The voltage of the first power conversion circuit 200 may be the input voltage of the first power conversion circuit 200, the output voltage of the first power conversion circuit 200 or the voltage of the bus capacitor 22. The voltage of the second power conversion circuit 202 is lower than 1500 volts (V). The voltage of the second power conversion circuit 202 may be the input voltage or the output voltage of the second power conversion circuit 202. In an embodiment, the first power conversion circuit 200 includes an AC/DC conversion circuit 200a and a primary circuit 200b. The AC/DC conversion circuit 200a is electrically connected to the AC terminal 10, the primary circuit 200b is electrically connected to the primary winding of the first transformer 201, and the bus capacitor 22 is electrically connected between the AC/DC conversion circuit 200a and the primary circuit 200b. The second power conversion circuit 202 is a secondary circuit and is electrically connected between the secondary winding of the first transformer 201 and the DC terminal 11.

The auxiliary circuit 21 includes a first power supply circuit 210, a second transformer 211 and a second power supply circuit 212. The first power supply circuit 210 is electrically connected to a corresponding second power conversion circuit 202 and the low-voltage bus 4. The first power supply circuit 210 is configured to receive the bus voltage of the low-voltage bus 4 for providing the auxiliary power to the corresponding second power conversion circuit 202. The first power supply circuit 210 is for example but not limited to a low-voltage side auxiliary power supply circuit. The second transformer 211 is electrically connected to the first power supply circuit 210. The second power supply circuit 212 is electrically connected to a corresponding first power conversion circuit 200 and a corresponding second transformer 211. The second power supply circuit 212 is configured to receive the bus voltage of the low-voltage bus 4 through the second transformer 211 for providing the auxiliary power to the corresponding first power conversion circuit 200. The second power supply circuit 212 is for example but not limited to a high-voltage side auxiliary power supply circuit. The second transformer 211 realizes the electrical isolation between the first power supply circuit 210 and the second power supply circuit 212. The first transformer 201 and the second transformer 211 may be an integrated magnetic element, such as sharing a box or a magnetic core. In another embodiment, the first transformer 201 and the second transformer 211 may be two independent magnetic elements respectively.

In the power supply system 1 of the present disclosure, the first voltage conversion circuit 3 converts the voltage of the bus capacitor 22 to the first voltage. The low-voltage bus 4 receives the first voltage provided by the first voltage conversion circuit 3 and provides the first voltage to the auxiliary circuits 21 of the plurality of power units 2 when the power supply system 1 is in the startup stage. In specific, in each of the plurality of power units 2, the first power supply circuit 210 of the auxiliary circuit 21 receives the bus voltage of the low-voltage bus 4 and provides the auxiliary power to the corresponding second power conversion circuit 202. The second power supply circuit 212 receives the bus voltage of the low-voltage bus 4 through the second transformer 211 and provides the auxiliary power to the corresponding first power conversion circuit 200.

The number of the first voltage conversion circuit 3 is not limited to one. In an embodiment, the number of the first voltage conversion circuits 3 is M, the number of the power units is N, where M and N are positive integers, and M is less than N. When the power supply system 1 is in the startup stage, the bus capacitor 22 of the power unit 2 has a pre-charge voltage. In addition, the bus capacitor 22 electrically connected to the first voltage conversion circuit 3 has a cut-off voltage. The pre-charge voltage and the cut-off voltage are preset. Therefore, a startup power provided by the bus capacitor 22 electrically connected to the first voltage conversion circuit 3 is expressed as the following formula:

W=½*C*(U₁²−U₂²)

In the above formula, W is the startup power, C is the capacitor of the bus capacitor 22, U1 is the pre-charge voltage, and U2 is the cut-off voltage. Therefore, a total startup power provided by M bus capacitors 22 electrically connected to M first voltage conversion circuit 3 is equal to M*W, and the total startup power is greater than the auxiliary power required by the power supply system 1 during the startup stage.

In an embodiment, the power supply system 1 of the present disclosure may be a N+X redundant system, and X power units 2 are redundant units. The number M of the first voltage conversion circuits 3 is less than or equal to X, where X is a positive integer.

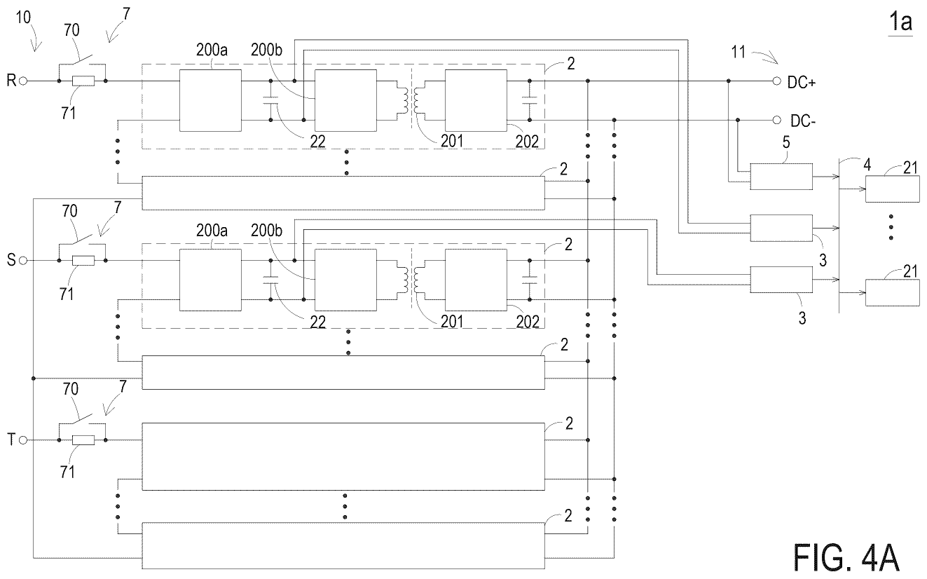

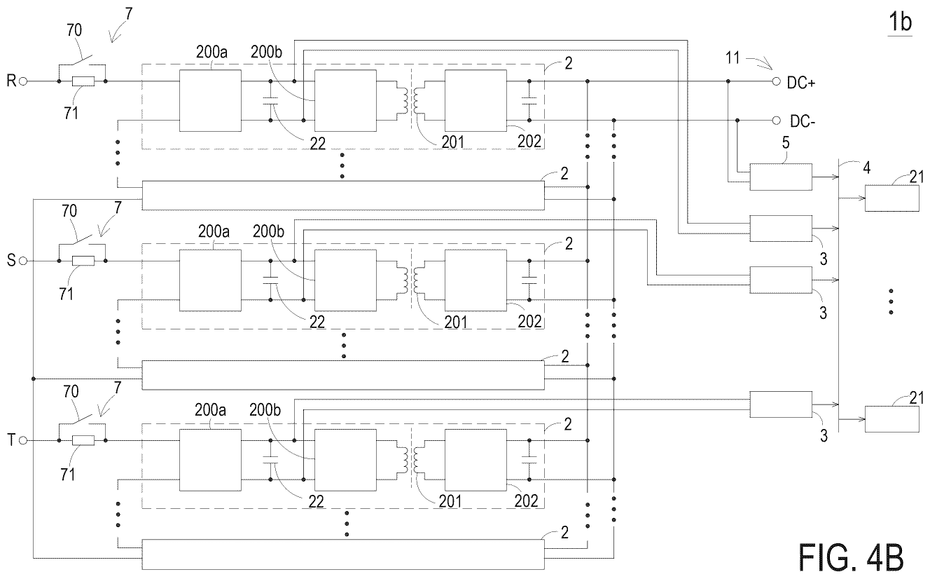

In an embodiment, the AC terminal 10 of the power supply system of the present disclosure is a three-phase AC terminal. FIG. 4A is a schematic block diagram illustrating a power supply system 1a according to another embodiment of the present disclosure. The elements of power supply system 1a of FIG. 4A that are similar with the elements of power supply system 1 of FIG. 3 are represented by the same reference numerals, and the detailed description thereof is omitted herein. In the power supply system 1a of this embodiment, the three-phase AC terminal 10 includes a R-phase, an S-phase and a T-phase. The plurality of power units 2 are electrically connected to the R-phase, S-phase, and T-phase, respectively. It should be noted that the auxiliary circuit 21 of the power unit 2 is shown independently in FIG. 4A for making the figure concise. In fact, each of the auxiliary circuits 21 is disposed in a corresponding power unit 2.

In an embodiment, the low-voltage bus 4 is electrically connected to the bus capacitor 22 in any one of the plurality of power units 2 of at least one phase. For example, as shown in the power supply system 1a of FIG. 4A, the low-voltage bus 4 is electrically connected to the bus capacitor 22 in any one of the plurality of power units 2 of the R-phase through one first voltage conversion circuit 3, and the low-voltage bus 4 is also electrically connected to the bus capacitor 22 of any one of the plurality of power units 2 of the S-phase through the other first voltage conversion circuit 3. In another embodiment, the bus capacitor 22 in at least one of the plurality of power units 2 of each phase is electrically connected to the first voltage conversion circuit 3, as shown in FIG. 4B. In the present disclosure, the number of the bus capacitors 22 electrically connected to the first voltage conversion circuit 3 and their corresponding phases may be adjusted according to actual needs and are not limited. Preferably, the bus capacitors 22 electrically connected to the first voltage conversion circuits 3 are evenly distributed in two or three phases.

In an embodiment, each phase of the power supply system 1a shown in the FIG. 4A has a N+X redundant configuration, and X power units 2 are redundant units. The number of the first voltage conversion circuits 3 is less than or equal to 3X, and the first voltage conversion circuits 3 are distributed in the three phases, where N and X are positive integers.

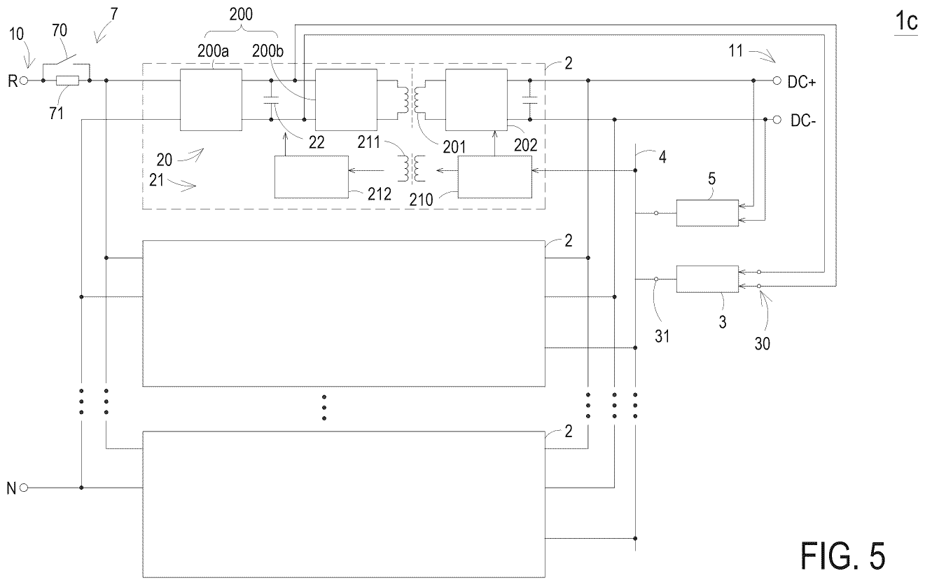

In the embodiments shown in FIGS. 3, 4A and 4B, the input terminals of the plurality of power units 2 are electrically connected in series to the AC terminal 10, and the output terminals of the plurality of power units 2 are electrically connected in parallel to the DC terminal 11. It should be noted that the electrical connection relationship between the input terminals of the plurality of power units 2 and the AC terminal 10, and the electrical connection relationship between the output terminals of the plurality of power units 2 and the DC terminal 11 are not limited. As shown in FIG. 5, the input terminals of the plurality of power units 2 may be electrically connected in parallel to the AC terminal 10.

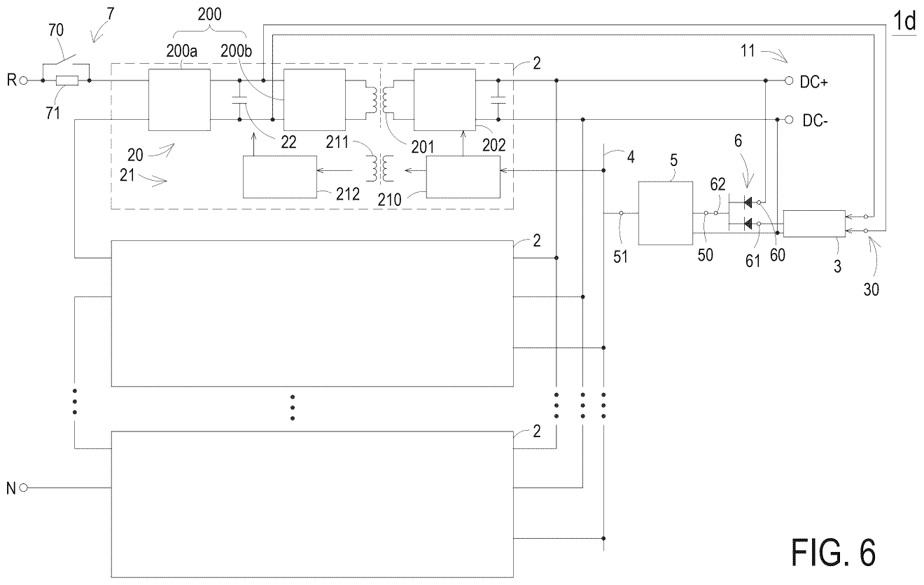

In an embodiment, the power supply system of the present disclosure further includes a selector. The selector is configured to select the voltage of the DC terminal or the first voltage and to provide the selected voltage to the auxiliary circuit of the power unit. FIG. 6 is a schematic block diagram illustrating a power supply system 1d according to another embodiment of the present disclosure. The elements of power supply system 1d of FIG. 6 that are similar with the elements of power supply system 1 of FIG. 3 are represented by the same reference numerals, and the detailed description thereof is omitted herein. In this embodiment, the power supply system 1d further includes a selector 6. The selector 6 includes a first input terminal 60, a second input terminal 61 and an output terminal 62. The first input terminal 60 is electrically connected to the DC terminal 11. For example, the first input terminal 60 is electrically connected to the DC positive terminal DC+. The second input terminal 61 is electrically connected to the first voltage conversion circuit 3. The selector 6 is configured to select the first voltage or the voltage of the DC terminal 11. The second voltage conversion circuit 5 includes an input terminal 50 and an output terminal 51. The input terminal 50 of the second voltage conversion circuit 5 is electrically connected to the output terminal 62 of the selector 6. The DC negative terminal DC−, the first voltage conversion circuit 3 and the second voltage conversion circuit 5 are electrically connected to each other. The output terminal 51 of the second voltage conversion circuit 5 is electrically connected to the auxiliary circuit 21 of the power unit 2 through the low-voltage bus 4. The second voltage conversion circuit 5 is configured to convert the first voltage or the voltage of the DC terminal 11 selected by the selector 6 to the bus voltage, and the low-voltage bus 4 provides the bus voltage to the auxiliary circuit 21 of each of the plurality of power units 2. When the first voltage is higher than the voltage of the DC terminal 11, the selector 6 selects the first voltage, and the second voltage conversion circuit 5 converts the first voltage to the bus voltage. Under this circumstance, the bus capacitor 22 provides the auxiliary power required by the power supply system 1d. When the power supply system 1d is in the startup stage, the first voltage is higher than the voltage of the DC terminal 11. When the first voltage is less than the voltage of the DC terminal 11, the selector 6 selects the voltage of the DC terminal 11, and the second voltage conversion circuit 5 converts the voltage of the DC terminal 11 to the bus voltage. Under this circumstance, the DC terminal 11 provides the auxiliary power required by the power supply system 1d. When the startup stage is over, the first voltage is less than the voltage of the DC terminal 11.

In the embodiment of the power supply system 1, the first voltage conversion circuit 3 converts the voltage (for example, 1500V) of the bus capacitor 22 to the low-voltage DC (for example, 24V). In the power supply system 1d shown in FIG. 6 of the present disclosure, the first voltage conversion circuit 3 converts the voltage of the bus capacitor 22 (for example, 1500V) to a voltage slightly smaller than the voltage of the DC terminal 11 (for example, 250V). Therefore, compared with the power supply system 1, the power supply system 1d shown in FIG. 6 may adopt a first voltage conversion circuit 3 with a lower step-down ratio, thereby further reducing costs.

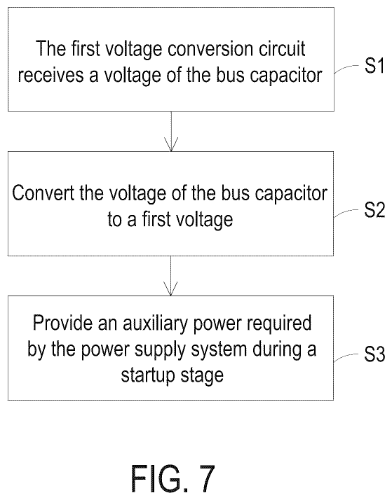

FIG. 7 is a schematic flow chart illustrating a power supply method according to an embodiment of the present disclosure. The power supply method of the present disclosure is applicable for the power supply system 1, 1a, 1b, 1c and 1d stated above. Please refer to FIGS. 3 and 7, and the power supply method of the present disclosure includes steps S1, S2 and S3. In the step S1, the first voltage conversion circuit 3 receives a voltage of the bus capacitor 22. In the step S2, the voltage of the bus capacitor 22 is converted to a first voltage. In the step S3, an auxiliary power required by the power supply system 1 during a startup stage is provided.

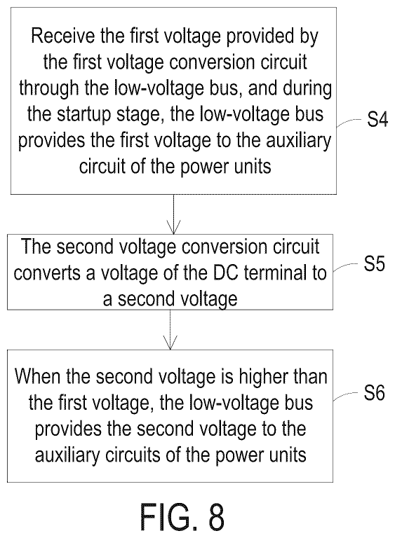

Please refer to FIGS. 3 and 8, and FIG. 8 is a schematic flow chart illustrating a power supply method according to another embodiment of the present disclosure. In this embodiment, the power supply method of the present disclosure includes steps S4, S5 and S6. In the step S4, receive the first voltage provided by the first voltage conversion circuit 3 through the low-voltage bus 4, and during the startup stage, the low-voltage bus 4 provides the first voltage to the auxiliary circuits 21 of the power units 2. In the step S5, the second voltage conversion circuit 5 converts a voltage of the DC terminal 11 to a second voltage. In the step S6, when the second voltage is higher than the first voltage, the low-voltage bus 4 provides the second voltage to the auxiliary circuits 21 of the power units 2.

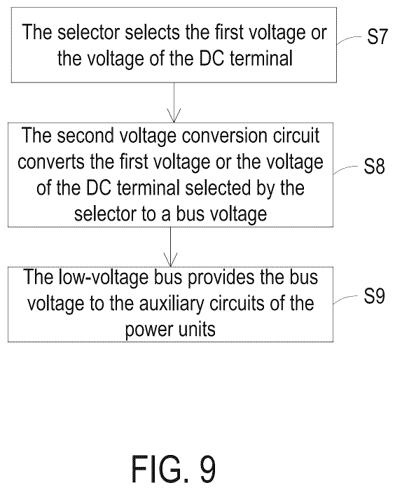

Please refer to FIGS. 6 and 9, and FIG. 9 is a schematic flow chart illustrating a power supply method according to another embodiment of the present disclosure. In this embodiment, the power supply method of the present disclosure includes steps S7, S8 and S9. In the step S7, the selector 6 selects the first voltage or the voltage of the DC terminal 11. In the step S8, the second voltage conversion circuit 5 converts the first voltage or the voltage of the DC terminal 11 selected by the selector 6 to a bus voltage. In the step S9, the low-voltage bus 4 provides the bus voltage to the auxiliary circuit 21 of the power unit 2.

In an embodiment, the step S7 further includes a sub-step: the selector 6 selects the first voltage when the first voltage is higher the voltage of the DC terminal 11. The step S8 further includes a sub-step: the second voltage conversion circuit 5 converts the first voltage to the bus voltage.

The present disclosure provides a power supply system and a power supply method. The at least one voltage conversion circuit is configured to receive the power of the bus capacitor and to provide the auxiliary power required by the power supply system during the startup stage. Instead of multiple high step-down ratio converters, the power supply system of the present disclosure only requires a small amount of voltage conversion circuits to complete the auxiliary power supply of the power supply system. As a result, the cost, volume and weight of the power supply system are reduced. In addition, the auxiliary power supply circuit of the present disclosure do not rely on an external power source, thereby improving the applicability.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply system having an AC terminal and a DC terminal, the power supply system comprising:
a plurality of power units, electrically connected between the AC terminal and the DC terminal respectively, wherein each of the plurality of power units comprises:
a main power circuit, comprising a bus capacitor; and
an auxiliary circuit, electrically connected to the main power circuit; and
at least one first voltage conversion circuit, wherein an input terminal of the first voltage conversion circuit is electrically connected to the bus capacitor of the main power circuit of one power unit, and the first voltage conversion circuit is configured for converting a voltage of the bus capacitor electrically connected to the first voltage conversion circuit to a first voltage and providing an auxiliary power required by the power supply system during a startup stage.

2. The power supply system according to claim 1, wherein an output terminal of the first voltage conversion circuit is electrically connected to auxiliary circuits of the plurality of power units through a low-voltage bus, and when a voltage of the DC terminal is less than a setting voltage, the low-voltage bus receives the first voltage provided by the first voltage conversion circuit as a bus voltage of the low-voltage bus, and provides the first voltage to the auxiliary circuits of the plurality of power units.

3. The power supply system according to claim 1, wherein during the startup stage, the first voltage conversion circuit provides the first voltage to the auxiliary circuits of the plurality of power units.

4. The power supply system according to claim 2, further comprising a second voltage conversion circuit electrically connected between the DC terminal and the low-voltage bus and configured for converting a voltage of the DC terminal to a second voltage, wherein when the second voltage is higher than the first voltage, the low-voltage bus receives the second voltage provided by the second voltage conversion circuit as the bus voltage of the low-voltage bus, and provides the second voltage to the auxiliary circuits of the plurality of power units.

5. The power supply system according to claim 4, wherein when the voltage of the DC terminal is higher than the setting voltage, the second voltage is higher than the first voltage.

6. The power supply system according to claim 1, further comprising:
a selector comprising a first input terminal electrically connected to the DC terminal, a second input terminal electrically connected to the first voltage conversion circuit and an output terminal, wherein the selector is configured for selecting the first voltage or a voltage of the DC terminal; and
a second voltage conversion circuit comprising an input terminal electrically connected to the output terminal of the selector and an output terminal electrically connected to the auxiliary circuits of the plurality of power units through a low-voltage bus, wherein the second voltage conversion circuit is configured for converting the first voltage or the voltage of the DC terminal selected by the selector to a bus voltage, and the low-voltage bus provides the bus voltage to the auxiliary circuits of the plurality of power units.

7. The power supply system according to claim 6, wherein when the first voltage is higher than the voltage of the DC terminal, the selector selects the first voltage, and the second voltage conversion circuit converts the first voltage to the bus voltage.

8. The power supply system according to claim 7, wherein when the power supply system is in the startup stage, the first voltage is higher than the voltage of the DC terminal.

9. The power supply system according to claim 2, wherein the main power circuit comprises:
a first power conversion circuit, electrically connected to the AC terminal;
a first transformer, electrically connected to the first power conversion circuit; and
a second power conversion circuit, electrically connected to the first transformer and the DC terminal,
wherein a voltage of the first power conversion circuit is higher than a voltage of the second power conversion circuit.

10. The power supply system according to claim 9, wherein the auxiliary circuit comprises:
a first power supply circuit, electrically connected to a corresponding second power conversion circuit and the low-voltage bus, wherein the first power supply circuit is configured to receive the bus voltage of the low-voltage bus and provide auxiliary power of the second power conversion circuit;
a second transformer, electrically connected to the first power supply circuit; and
a second power supply circuit, electrically connected to a corresponding first power conversion circuit and a corresponding second transformer, wherein the second power supply circuit is configured to receive the bus voltage of the low-voltage bus through the second transformer and provide auxiliary power of the second power conversion circuit.

11. The power supply system according to claim 1, wherein the power supply system is a N+X redundant system, and a number of the first voltage conversion circuits is less than or equal to X, wherein N and X are positive integers.

12. The power supply system according to claim 1, wherein the AC terminal is a three-phase AC terminal, and the plurality of power units are electrically connected to any phase of the three-phase AC terminal respectively; wherein each phase of the power supply system has a N+X redundant configuration, and a number of the first voltage conversion circuits is less than or equal to 3X, wherein N and X are positive integers.

13. The power supply system according to claim 12, wherein the first voltage conversion circuits are distributed among the three phases of the power supply system.

14. The power supply system according to claim 1, wherein during the startup stage, the bus capacitors of the plurality of power units have a pre-charge voltage, the bus capacitor electrically connected to the first voltage conversion circuit has a cut-off voltage, and a startup power provided by the bus capacitor electrically connected to the first voltage conversion circuit is expressed as the following formula:
W=½*C*(U₁²−U₂²)
wherein W is the startup power, C is a capacitance of the bus capacitor, U1 is the pre-charge voltage and U2 is the cut-off voltage.

15. The power supply system according to claim 14, further comprising M first voltage conversion circuits, wherein a total startup power provided by M bus capacitors electrically connected to the M first voltage conversion circuits is equal to M*W, and the total startup power is greater than or equal to the auxiliary power required by the power supply system during the startup stage.

16. A power supply method for a power supply system, wherein the power supply system has an AC terminal, a DC terminal, a plurality of power units and at least one first voltage conversion circuit, the plurality of power units are electrically connected between the AC terminal and the DC terminal respectively, each of the plurality of power units comprises a main power circuit and an auxiliary circuit, the main power circuit comprises a bus capacitor, the auxiliary circuit is electrically connected to the main power circuit, an input terminal of each first voltage conversion circuit is electrically connected to a bus capacitor of one power unit, and wherein the power supply method comprises steps of:
(a) the first voltage conversion circuit receiving a voltage of the bus capacitor;
(b) converting the voltage of the bus capacitor to a first voltage; and
(c) providing an auxiliary power required by the power supply system during a startup stage.

17. The power supply method according to claim 16, wherein the power supply system further comprises a low-voltage bus, and the power supply method further comprises a step of:
(d) the low-voltage bus receiving the first voltage, and providing the first voltage to the auxiliary circuits of the plurality of power units.

18. The power supply method according to claim 17, wherein the power supply system further comprises a second voltage conversion circuit electrically connected to the DC terminal, and the power supply method further comprises steps of:
(e) the second voltage conversion circuit receiving a voltage of the DC terminal and converting the voltage of the DC terminal to a second voltage; and
(f) when the second voltage is higher than the first voltage, the low-voltage bus providing the second voltage to the auxiliary circuits of the plurality of power units.

19. The power supply method according to claim 16, wherein the power supply system further comprises a selector and a second voltage conversion circuit, the selector comprises a first input terminal electrically connected to the DC terminal, a second input terminal electrically connected to the first voltage conversion circuit and an output terminal, the second voltage conversion circuit comprises an input terminal electrically connected to the output terminal of the selector and an output terminal electrically connected to the auxiliary circuits of the plurality of power units through a low-voltage bus, and the power supply method further comprises steps of:
(g) the selector selecting the first voltage or the voltage of the DC terminal;
(h) the second voltage conversion circuit converting a voltage selected by the selector to a bus voltage; and
(i) the low-voltage bus providing the bus voltage to the auxiliary circuits of the plurality of power units.

20. The power supply method according to claim 19, wherein the step (g) further comprises a sub step of:
(g1) when the first voltage is higher the voltage of the DC terminal, the selector selecting the first voltage,
wherein the step (h) further comprises a sub step of:
(h1) the second voltage conversion circuit converting the first voltage to the bus voltage.
